(19) United States
(12) Patent Application Publication
(10) Pub. No.: US 2007/0059564 A1
(43) Pub. Date: Mar. 15, 2007

(54) Thin film structure with decreased C-axis distribution

(75) Inventors: Timothy J. Klemmer, Pittsburgh, PA (US); Charles F. Brucker, Pleasanton, CA (US); Kalman Pelhos, Pittsburgh, PA (US)

Correspondence Address: PIETRAGALLO, BOSICK & GORDON LLP, ONE OXFORD CENTRE, 38TH FLOOR, 301 GRANT STREET, PITTSBURGH, PA, 15219-6404, US

(73) Assignee: Seagate Technology LLC, Scotts Valley, CA (US)

(21) Appl. No.: 11/226,634

(22) Filed: Sep. 14, 2005

(51) Int. Cl. G11B 5/64; B32B 3/28; G11B 5/706

(52) U.S. Cl. 428/848.3; 428/692.1; 428/141; 428/156; 428/163; 428/164; 428/167

(57) ABSTRACT

A thin film structure in the form of, for example, a magnetic recording medium having a deceased C-axis distribution is provided. The structure includes a substrate having a first surface and a second surface non-parallel to the first surface, a seed layer overlying the first surface and the second surface of the substrate and a magnetic material layer on the seed layer. The magnetic material layer has a C-axis tilted with respect to an axis perpendicular to the magnetic material layer, i.e., a surface normal of the magnetic material layer. The seed layer has a columnar structure oriented generally perpendicular to either the first surface or the second surface of the substrate. The columnar structure of the seed layer acts as a template to epitaxial growth.

### FIELD OF THE INVENTION

The invention relates generally to thin film structures with decreased C-axis distribution and, more particularly, to a thin film structure that may be constructed in the form of a recording media having decreased C-axis distribution.

### BACKGROUND INFORMATION

Demands are currently being made to further increase the capacity of magnetic data storage. A major objective of research efforts in thin film magnetic materials is to make recording media with properties, which are suitable for recording at higher data densities. Achievement of higher recording densities is impaired by several problems. First, as the quantity of magnetic flux corresponding to the data becomes smaller, it becomes increasingly difficult to separate the data signal from the noise. Second, as the recording density increases without corresponding improvement in the materials, the super-paramagnetic limit of the materials is approached so that thermal energy can potentially randomize the data stored in the magnetic material. Both of these problems are related to the energy density associated with the magnetic anisotropy of the magnetic material, commonly quantified by the constant Kᵤ for a particular material. Materials with higher Kᵤ values are desired for recording media to avoid the problems above.

In materials with larger Kᵤ values, the property of media coercivity (H_{c}) is also generally increased. Increased coercivity of the magnetic media in turn requires larger write field strength to be generated by the recording heads. The higher the coercivity the higher the required write field strength and hence the more difficult it is to successfully record data in the magnetic material.

A method proposed to overcome the problems of high write field strength requirements to write high Kᵤ materials is to tilt the magnetization away from the surface normal in perpendicular recording or from the surface plane in longitudinal recording. For this proposal, media must be created where the angle between the direction of preferred magnetization (magnetic easy axis) and the surface normal falls between 0° (perpendicular media) and 90° (longitudinal media), also referred to as tilted media. Many attempts have been made to produce tilted media without success.

One difficulty in producing a tilted media is controlling the C-axis distribution. C-axis distribution is defined as the full width at half maximum (FWHM) of the dispersion of the C-axis about a reference direction and for tilted media the reference direction is the average C-axis tilt. The distribution can be measured by X-ray diffraction by doing rocking curves and/or pole figures. A commonly observed problem for tilted media is that the C-axis distribution increases for increasing tilt angle where the increased C-axis distribution is not desirable.

Accordingly, there is identified a need for an improved thin film structure having a decreased C-axis distribution.

In addition, there is identified a need for an improved data storage medium having a decreased C-axis distribution. In particular, a data storage medium constructed in the form of a tilted media and having a decreased C-axis distribution is desired.

There is further identified a need for a thin film structure, for example, a data storage medium, that overcomes disadvantages, shortcomings, and limitations of known thin film structures and, in particular, known data storage mediums.

### SUMMARY OF THE INVENTION

The invention meets the identified need, as well as other needs, as will be more fully understood following a review of this specification and drawings.

An aspect of the present invention is to provide a thin film structure comprising a substrate having a first surface and a second surface non-parallel to the first surface, a seed layer overlying the first surface and the second surface of the substrate, and a magnetic material layer on the seed layer. The magnetic material layer has a C-axis tilted with respect to the magnetic material layer surface normal. The seed layer has a columnar structure oriented generally perpendicular to either the first surface or the second surface of the substrate. The columnar structure of the seed layer acts as a template for epitaxial growth. In one embodiment of the invention, the first surface is generally perpendicular to the second surface. In another embodiment of the invention, the C-axis tilt angle is in the range of about 20° to about 70°.

Another aspect of the present invention is to provide a data storage medium comprising a sawtooth shaped substrate, a seed layer structure deposited on the substrate, and a storage layer deposited on the seed layer structure. The storage layer has a C-axis tilted with respect to a surface normal of the storage layer. In one embodiment of the invention, the storage layer is a magnetic storage medium.

A further aspect of the present invention is to provide a data storage apparatus comprising a recording device and a storage medium positioned adjacent the recording device and having a surface normal. The storage medium comprises a substrate having a first surface and a second surface non-parallel to the first surface, a seed layer structure overlying the substrate, and a storage layer on the seed layer structure. The storage layer has a C-axis tilted with respect to the surface normal. In one embodiment of the invention, the C-axis tilt angle is in the range of about 20° to about 70°.

These and other aspects of the present invention will be more apparent from the following description.

### BRIEF DESCRIPTION OF THE DRAWINGS

FIG. 1 is a pictorial representation of a disc drive that may utilize a perpendicular, longitudinal, or tilted recording mediums or combinations thereof in accordance with the invention.

FIG. 2 illustrates an embodiment of a thin film structure and, in particular, a magnetic recording medium constructed in accordance with the invention.

FIG. 3 illustrates an additional embodiment of a thin film structure and, in particular, a magnetic recording medium constructed in accordance with the invention.

FIG. 4 illustrates an image of an embodiment of the invention and deposition geometry therefore for further illustrating the invention.

FIG. 5a is an (0002) Ru pole figure illustrating the C-axis distribution of an example of the present invention.

FIG. 5b is an (0002) Psi scan showing a C-axis tilt and C-axis distribution for an illustration of the invention.

FIG. 6 illustrates a (0002) Psi scan showing a C-axis tilt and C-axis distribution for a “symmetric” and “0°” geometry of the target racetrack and substrate.

### DETAILED DESCRIPTION

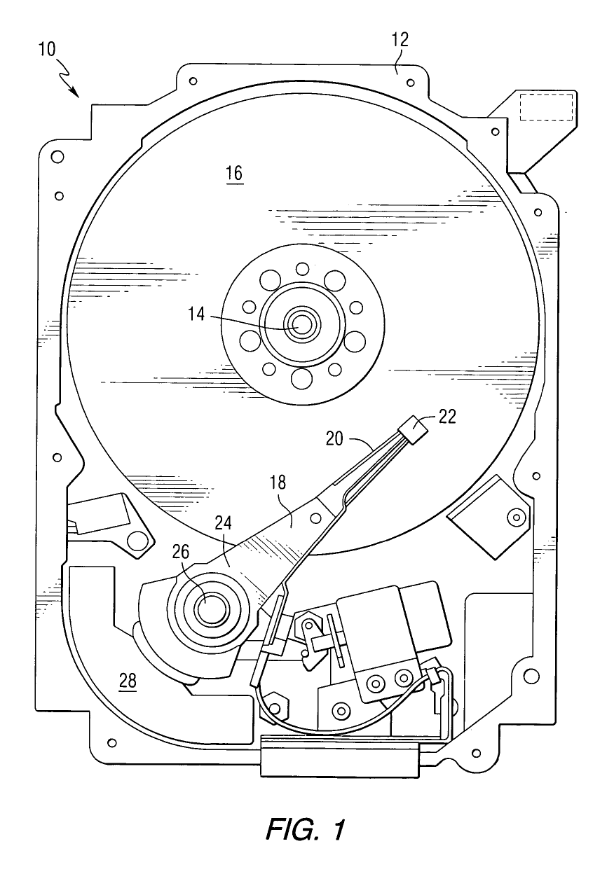

FIG. 1 is a pictorial representation of a disc drive 10 that can utilize a thin film structure accordance with this invention. The disc drive 10 includes a housing 12 (with the upper portion removed and the lower portion visible in this view) sized and configured to contain the various components of the disc drive. The disc drive 10 includes a spindle motor 14 for rotating at least one magnetic storage medium, such as a magnetic recording medium 16, which may be a perpendicular, longitudinal and/or tilted magnetic recording medium, within the housing 12. At least one arm 18 is contained within the housing 12, with each arm 18 having a first end 20 with a recording head or slider 22, and a second end 24 pivotally mounted on a shaft by a bearing 26. An actuator motor 28 is located at the arm's second end 24 for pivoting the arm 18 to position the recording head 22 over a desired sector or track of the disc 16. The actuator motor 28 is regulated by a controller, which is not shown in this view and is well known in the art.

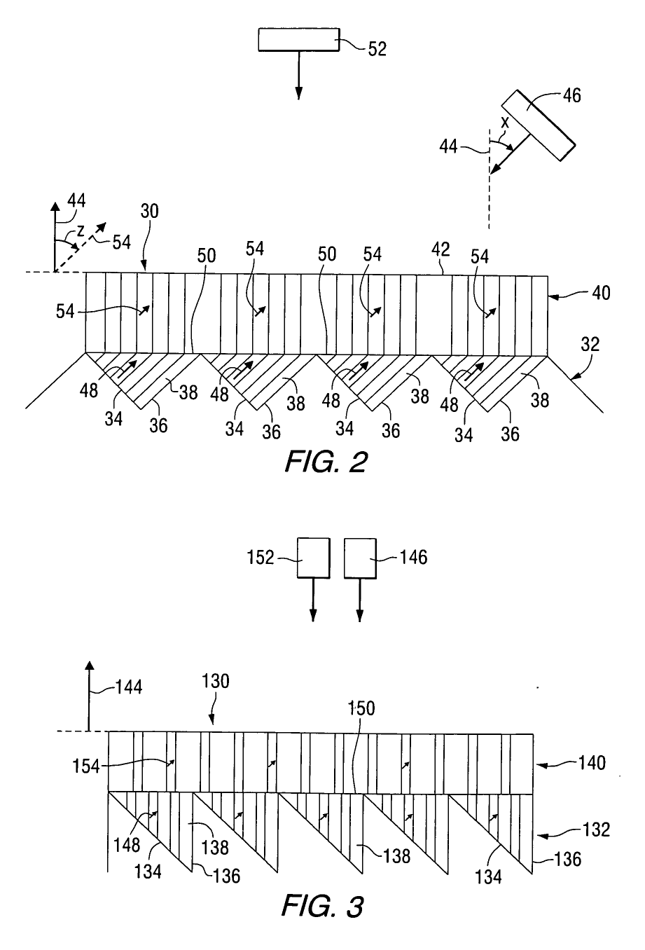

Referring to FIG. 2, there is illustrated an embodiment of the invention in the form of a thin film structure. Specifically, the thin film structure is constructed as a magnetic recording medium 30. The magnetic recording medium 30 is constructed in the form of a tilted magnetic recording medium, as will be explained in more detail herein. While this embodiment of the invention is illustrated in the context of a magnetic recording medium, the invention may also have other utility and applications in the form of a thin film structure as well. For example, the invention may also have utility as a ferroelectric media.

Still referring to FIG. 2, the magnetic recording medium 30 includes a substrate 32 having at least one first surface 34 and at least one second surface 36. As shown, the substrate 32 includes a plurality of first surfaces 34 and a plurality of second surfaces 36. The first surface 34 and the second surface 36 of the substrate 32 are non-parallel to each other. In one embodiment, the substrate 32 has a generally sawtooth shaped configuration. In another embodiment of the invention, the first surface 34 is substantially planar and the second surface 36 is also substantially planar. In another embodiment of the invention, the first surface 34 is generally perpendicular to the second surface 36.

The substrate 32 may be formed of, for example, Al, amorphous glass, Si, glass ceramic, sapphire, or MgO. Furthermore, the substrate 32 may be manufactured using, for example, nano-imprint technology or nano-lithography so as to provide the substrate 32. For example, patterning techniques may be used to create the substrate 32 structure. E-beam lithography, photolithography, or other types of lithography may also be used for constructing the sawtooth structure. Additionally, faceting of crystalline planes of single crystals by, for example, chemical etching (or ion etching) may also be used for fabricating the substrate 32.

Still referring to FIG. 2, the magnetic recording medium 30 also includes a seed layer 38 deposited on or overlying the first surfaces 34 and the second surfaces 36 of the substrate 32. The seed layer may be formed of, for example, Ru, Ta, Zr, Cr, Hf, Ir, Ag, Pt, or Au.

Referring again to FIG. 2, the magnetic recording medium 30 also includes a storage layer or magnetic recording layer 40 deposited on or overlying the seed layer 38. The magnetic recording layer 40 includes a magnetic layer surface 42 and a surface normal, as represented by arrow 44 that extends generally perpendicular to the magnetic layer surface. The surface normal 44 as used herein is also representative of a macroscopic normal of the substrate 32. The magnetic recording layer 40 may be formed of, for example, CoPt and alloys thereof, FePt, FePd, CoPt, SmCo, YCo, rare earth-Co, CoPtCr, CoPtCrB, or Co alloys.

Prior to the magnetic recording layer 40 being deposited, the seed layer 38 is deposited onto the first surfaces 34 and the second surfaces 36 of the substrate 32. In one embodiment of the invention, the selected material for the seed layer 38 may be deposited from a target 46 using an oblique physical vapor deposition process. The angle of the oblique deposition may be at an angle X in the range of about 20° to about 70° from the surface normal 44. This results in the seed layer 38 having a columnar, granular structure oriented generally perpendicular to the first surfaces 34 of the substrate 32. This also results in the seed layer 38 having a crystalline C-axis also oriented generally perpendicular to the first surfaces 34, wherein the C-axis of the seed layer 38 is generally represented by the arrows 48. Once the seed layer 38 is deposited onto the substrate 32, it will be appreciated that a process such as, for example, chemical mechanical planarization (CMP) may be utilized to provide the seed layer with a generally planar or smooth seed layer surface 50.

Alternatively, the seed layer 38 could be deposited in such a manner that the columnar structure is oriented generally perpendicular to the second surfaces 36 of the substrate 32 as well which would result in the seed layer 38 having a crystalline C-axis also oriented generally perpendicular to the second surfaces 36.

It will be appreciated that in accordance with the invention, the seed layer structure 38 has various roles necessary to achieve the desired tilt in the subsequently deposited magnetic recording layer 40. For example, the seed layer 38 must create tilted crystallographic texture. In addition, the seed layer 38 must promote local epitaxial growth of the magnetic recording layer 40. These roles describe influences asserted by the seed layer 38 as a whole on the magnetic recording layer 40 and/or within the seed layer 38 itself.

The seed layer 38 may be formed of, for example, a single layer of a single material, several layers of different materials or a single layer of continuously changing material composition. As described, the seed layer 38 in one embodiment of the invention is formed by oblique deposition. However, alternate forms of deposition may be used so as to establish the desired columnar growth on the surfaces 34 (or on the surfaces 36) of the substrate 32.

The material of the seed layer 38 develops tilted columnar growth, for example tilted grains, when deposited on the substrate 32 and should therefore be suitable for growing or developing the desired tilted grain structure of seed layer 38. The material for seed layer 38 should be adaptable to a variety of substrate materials and surfaces. Generally, the tilted columnar growth will be the result of oblique deposition or the particular form of deposition chosen for the desired type of growth.

An additional requirement for seed layer 38 is to create tilted crystallographic texture. The tilted crystallographic texture of the seed layer 38 does not require uniaxial symmetry or a single high symmetry axis. Seed layer 38 must create a tilted crystallographic template for magnetic recording layer 40 by presenting preferred, tilted crystallographic orientations at the interface 50 with the magnetic recording layer 40.

The materials for seed layer 38 are chosen so that the desired crystalline properties created by seed layer 38 are carried into the subsequently deposited layers. For example, seed layer 38 must have sufficient crystal lattice matching with the magnetic recording layer 40 at interface 50 such that epitaxy occurs during growth of the magnetic recording layer 40. Seed layer 38 must provide an epitaxial growth template for the subsequently deposited magnetic material layer 40.

Still referring to FIG. 2, once the seed layer 38 is formed on the substrate 32, the magnetic recording layer 40 is deposited onto the seed layer 38. In one embodiment of the invention, the chosen material or materials that form the magnetic recording layer 40 are deposited from a target 52 in a direction that is generally normal to the surface of the seed layer 50, i.e., the magnetic recording layer 40 is deposited in a direction that is generally parallel to the surface normal 44 of the recording medium 30.

The magnetic recording layer 40 may be formed of high coercivity materials. In materials with a single preferred crystalline axis, the magnetic easy axis tends to align with the C-axis creating magneto crystalline anisotropy. As illustrated in FIG. 2, the C-axis of the magnetic recording layer 40, as generally represented by arrows 54, are aligned with the C-axis 48 of the seed layer 38. The C-axis 54 of the magnetic recording layer is positioned at a C-axis tilt angle Z with respect to the surface normal 44 which may be in the range of about 20° to about 70°.

Referring to FIG. 3, there is illustrated an additional embodiment of the invention. Specifically, there is illustrated a thin film structure in the form of a magnetic recording medium 130. The recording medium 130 is shown as a tilted media. The magnetic recording medium 130 includes a substrate 132 having a plurality of first surfaces 134 and a plurality of second surfaces 136.

Still referring to FIG. 3, the magnetic recording medium 130 also includes a seed layer 138 overlying the first surfaces 134 and the second surfaces 136 of the substrate 132. In contrast to the embodiment illustrated in FIG. 2, in this embodiment of the invention, the seed layer 138 is deposited normally to the desired final seed layer surface 150 from a target 146. The seed layer 138 has a columnar, granular structure which, in this embodiment, is deposited on the first surfaces 134 of the substrate 132. This results in the seed layer 138 having a C-axis oriented as illustrated by arrows 148.

The magnetic recording medium 130 further includes a magnetic recording layer 140 deposited on the seed layer 138. The magnetic recording layer 140 is also deposited normally to the seed layer surface 150. In other words, both the seed layer 138 and the magnetic recording layer 140 are deposited in a direction that is generally parallel to the surface normal 144 of the magnetic recording medium 130. As described hereinabove with reference to FIG. 2 and the embodiment set forth therein, the magnetic recording layer 140 will include a C-axis, represented generally by arrows 154 that are substantially aligned with the C-axis 148 of the seed layer 138.

In accordance with an important aspect of the invention, the substrate such as, for example, substrate 32 as illustrated in FIG. 2 and substrate 132 as illustrated in FIG. 3 herein, are structured and arranged to control the C-axis tilt and C-axis distribution. These substrates can be used to decrease the C-axis distribution of a tilted media and to help control the C-axis tilt as well.

In order to illustrate the invention, a thin film structure, such as the magnetic recording medium 30 illustrated in FIG. 2, was constructed. The substrate 32 was replicated using an optical grating obtained from Edmund Industrial Optics (Edmund Industrial Optics Part #NT 43-753). This structure allowed for generally replicating the substrate of the invention and it will be appreciated that in order to form an actual magnetic recording medium, a substrate structure having smaller wavelengths such as approaching the 50 nm range or below would be necessary. However, the optical grating used is a sufficient replica of the desired substrate for illustrating the invention.

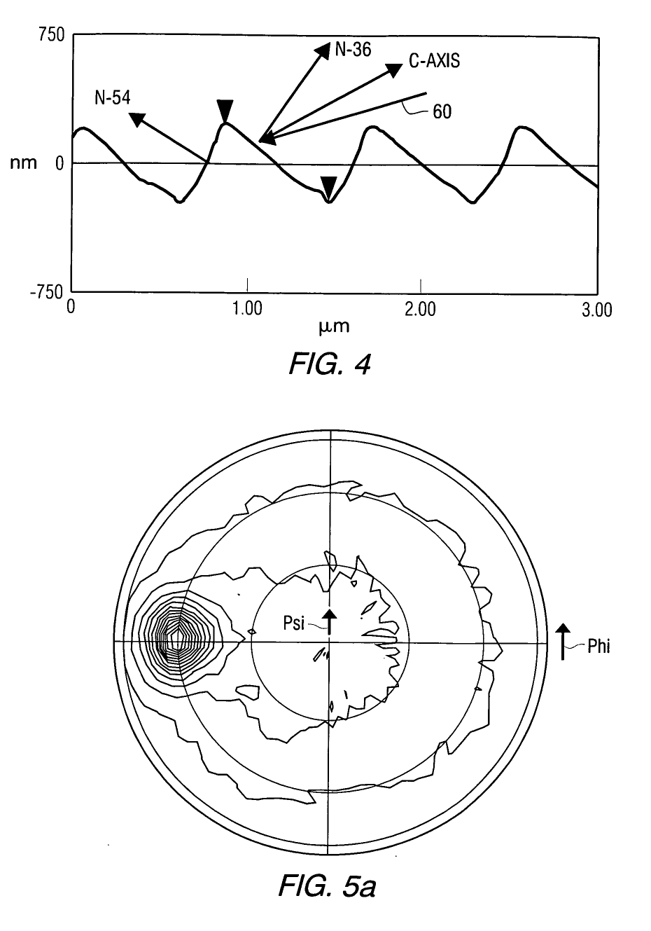

Once the substrate for illustrating the invention was obtained, a seed layer formed of a 20 nm layer of amorphous FeCoB was deposited. Because the optical grating used for this illustration had a layer of Au deposited on the surface of the grating, it was necessary to make sure there was not a local epitaxy of our films to the Au. Thus, there was deposited a 10 nm layer of Ag and then a 10 nm layer of Ru, both obliquely deposited at an oblique angle of approximately 70° from the substrate normal, which in this example is defined as the macroscopic normal of the substrate. FIG. 4 illustrates a view of the geometry used in this illustration obtained by atomic force microscopy (AFM). For example, FIG. 4 illustrates and defines the surface normals of the surfaces of the substrate used. N-36 represents approximately 36° from the substrate normal (i.e., the macroscopic substrate normal) for the corresponding substrate surface and N-54 represents approximately 54° from the substrate normal (i.e., the macroscopic substrate normal) for the other corresponding substrate surface. The angle of deposition is illustrated by arrow 60.

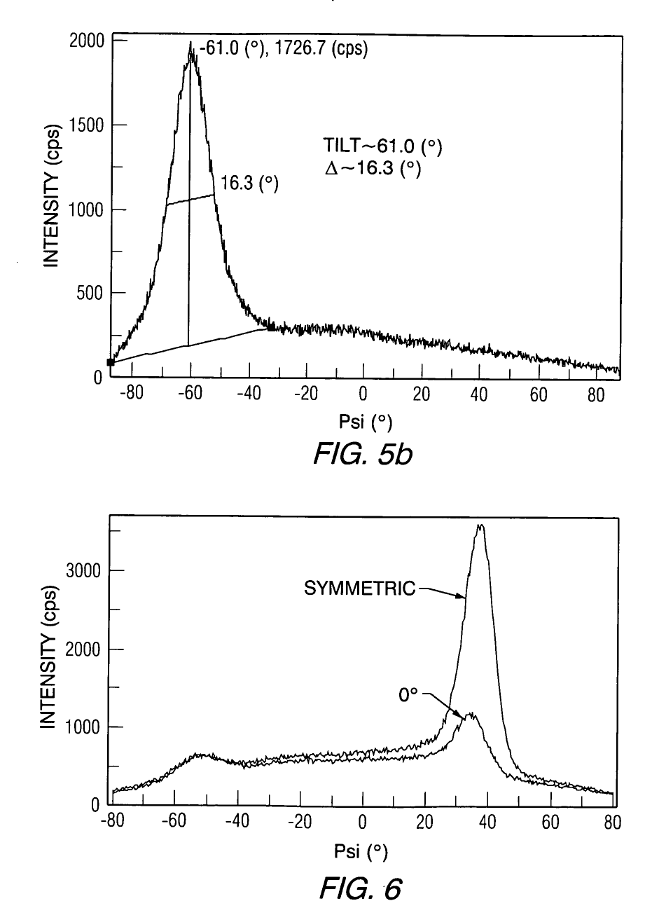

The measured C-axis distribution of the Ru layer is then illustrated in FIGS. 5a and 5b. Specifically, FIG. 5a is the (0002) pole figure and FIG. 5b is the Psi scan for the described structure. Specifically, FIGS. 5a and 5b show a C-axis tilt of about 61° and a C-axis distribution (Δ)of about 16.3°. As a comparison, the best C-axis tilt for any seed layer that we have obtained for oblique incidence on a “flat” substrate (i.e., no sawtooth substrate) was approximately 30° to about 35° and with a C-axis distribution of approximately 30°. Thus, it is clear that the substrates described herein can be used to help define the C-axis tilt and can decrease the C-axis distribution.

Referring to FIG. 6, there are shown the results of a variation of the example of the invention described hereinabove. The difference between “symmetric” and “0°” describes the geometry of the target to substrate placement in our particular experiment. Symmetric describes the target and substrate having their centers aligned such that the atomic flux arrives radially from the sputtering target race-track (e.g., see FIG. 2). The 0° deposition geometry describes the centers being misaligned such that part of the race track is opposite the center of the substrate such that the incoming flux of atoms predominantly arrives along the sample normal, although there is some atoms arriving from other regions of the race-track (e.g., see FIG. 3). These are examples of when the deposited atoms arrive on average along the sample normal. For both cases the tilt is found to be along the normal to the surfaces but with a much lower distribution of the C-axis as compared to other methods of making tilted media. This shows that the surface geometry of the substrate can be used to make tilted media with a decreased C-axis distribution for both a normal deposition geometry where the atomic flux comes normal to the substrate or for an oblique incidence geometry where the flux arrives at an angle to the sample normal.

Tilted media prepared by oblique deposition onto flat substrates requires amorphous/nanocrystalline seed layers to be initially deposited obliquely. As these seed layers evolve a microscopic roughness forms with a distribution of the sample normal biased toward the incoming flux of atoms. This roughness evolution helps in defining the crystalline tilted texture of the next layer. The result is that the distribution of the crystalline preferred orientations inherits the distribution of the sample normals that are aligned toward the incoming flux of atoms during oblique deposition. By creating the substrate in accordance with the invention, we better define the sample normals and thereby create a better tighter distribution of the C-axis, i.e., decreasing the C-axis distribution.

Whereas particular embodiments have been described herein for the purpose of illustrating the invention and not for the purpose of limiting the same, it will be appreciated by those of ordinary skill in the art that numerous variations of the details, materials, and arrangement of parts may be made within the principle and scope of the invention without departing from the invention as described in the appended claims.

What is claimed is:

1. A thin film structure, comprising:
a substrate having a first surface and a second surface non-parallel to the first surface;
a seed layer overlying the first surface and the second surface; and
a magnetic material layer overlying the seed layer.

2. The thin film structure of claim 1, wherein the first surface and/or the second surface are substantially planar.

3. The thin film structure of claim 1, wherein the seed layer has a columnar structure oriented generally perpendicular to either the first surface or the second surface of the substrate.

4. The thin film structure of claim 1, wherein the seed layer has a C-axis oriented generally perpendicular to either the first surface or the second surface of the substrate.

5. The thin film structure of claim 3, wherein the columnar structure of the seed layer acts as a template for epitaxial growth.

6. The thin film structure of claim 1, wherein the first surface is generally perpendicular to the second surface.

7. The thin film structure of claim 1, wherein the magnetic material layer has a surface normal and a C-axis tilted with respect to the surface normal.

8. The thin film structure of claim 7, wherein the C-axis is tilted at an angle in the range of about 20° to about 70°.

9. The thin film structure of claim 1, wherein the substrate is formed of at least one of Al, amorphous glass, Si, glass ceramic, sapphire, or MgO.

10. The thin film structure of claim 1, wherein the seed layer is formed of at least one of Ru, Ta, Zr, Cr, Hf, Ir, Ag, Pt, or Au.

11. The thin film structure of claim 1, wherein the magnetic material layer is formed of at least one of CoPt and alloys thereof, FePt, FePd, CoPt, SmCo, YCo, rare earth-Co, CoPtCr, CoPtCrB, or Co alloys.

12. The thin film structure of claim 1 formed as a data storage medium.

13. The thin film structure of claim 12, wherein the data storage medium has a C-axis distribution in the range of about 0° to about 20°.

14. A data storage medium, comprising:
a sawtooth shaped substrate;
a seed layer structure deposited on the sawtooth shaped substrate; and
a storage layer deposited on the seed layer structure.

15. The data storage medium of claim 14, wherein the storage layer is magnetic.

16. The data storage medium of claim 14, wherein the storage layer has a surface normal and a C-axis tilted with respect to the surface normal.

17. The data storage medium of claim 16, wherein the C-axis is tilted at an angle in the range of about 20° to about 70°.

18. A data storage apparatus, comprising:
a recording device; and
a storage medium positioned adjacent the recording device and having a surface normal, the storage medium comprising:
a substrate having a first surface and a second surface non-parallel to the first surface;
a seed layer structure overlying the substrate; and
a storage layer on the seed layer structure.

19. The data storage apparatus of claim 18, wherein the storage layer has a C-axis tilted with respect to the surface normal of the storage medium.

20. The data storage apparatus of claim 19, wherein the C-axis is tilted at an angle in the range of about 20° to about 70°.
